(19) United States
(12) Patent Application Publication
(10) Pub. No.: US 2008/0092146 A1
(43) Pub. Date: Apr. 17, 2008

(54) COMPUTING MACHINE

(76) Inventors: Paul Chow, Mississauga (CA); Christopher Andre Madill, Toronto (CA); Arun Mohanial Patel, Toronto (CA); Manuel Alejandro Saldana De Fuentes, Toronto (CA)

Correspondence Address: REISING, ETHINGTON, BARNES, KISSELLE, P.C., P O BOX 4390, TROY, MI, 48099-4390, US

(21) Appl. No.: 11/869,270

(22) Filed: Oct. 9, 2007

Related U.S. Application Data
(60) Provisional application No. 60/850,251, filed on Oct. 10, 2006.

(51) Int. Cl. G06F 15/17

(52) U.S. Cl. 719/313

(57) ABSTRACT

An architecture for a scalable computing machine built using configurable processing elements, such as FPGAs, is provided. The machine can enable implementation of large scale computing applications using a heterogeneous combination of hardware accelerators and embedded microprocessors spread across many FPGAs, all interconnected by a flexible communication network structure.

### PRIORITY

This application claims priority from U.S. Provisional Patent Application 60/850,251, filed on Oct. 10, 2006, the contents of which are incorporated herein by reference in its entirety.

### FIELD

The present specification relates generally to computing and more particularly relates to an architecture and programming method for a computing machine.

### BACKGROUND

It has been shown that a small number of Field Programmable Gate Arrays (“FPGA”) can significantly accelerate certain computing processes by up to two or three orders of magnitude. There are particularly intensive large-scale computing applications, such as, by way of one non-limiting example, molecular dynamics simulations of biological systems, that underscore the need for even greater speedups. For example, in molecular dynamics, greater speedups are needed to address naturally relevant lengths and time scales. Rapid development and deployment of computers based on FPGAs remains a significant challenge.

### SUMMARY

In an aspect of the present specification, there is provided an architecture for a scalable computing machine built using configurable processing elements, such as FPGAs. Such a configurable processing element can provide the resources and ability to define application-specific hardware structures as required for a specific computation, where the structures include, but are not limited to, computing circuits, microprocessors and communications elements. The machine enables implementation of large scale computing applications using a heterogeneous combination of hardware accelerators and embedded microprocessors spread across many configurable processing elements, all interconnected by a flexible communication structure. Parallelism at multiple levels of granularity within an application can be exploited to obtain the maximum computational throughput. It can be desired to implement computing machines according to the teachings herein that describe a hardware architecture and structures to implement the architecture, as well as an appropriate programming model and design flow for implementing applications.

### BRIEF DESCRIPTION OF THE DRAWINGS

FIG. 1 is a schematic representation of a computing machine in accordance with an embodiment.

FIG. 2 is a schematic representation of a computing machine in accordance with another embodiment.

FIG. 3 is a schematic representation of a computing machine in accordance with another embodiment.

FIG. 4 is a schematic representation of a computing machine in accordance with another embodiment.

FIG. 5 is a flow-chart depicting a method of programming a computing machine in accordance with another embodiment.

FIG. 6 shows a system for performing the method of FIG. 5.

FIG. 7 shows an example of how FIG. 5 is performed.

FIG. 8 shows a stack for an implementation of an MPI.

FIG. 9 shows an example application implemented based on embodiments discussed herein.

### DETAILED DESCRIPTION OF THE EMBODIMENTS

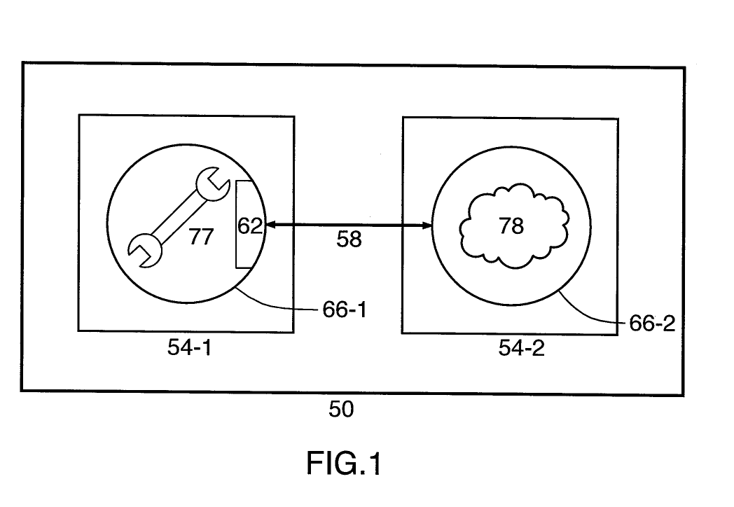

Referring now to FIG. 1, a computing machine in accordance with an embodiment is indicated generally at 50. Machine 50 comprises a plurality of configurable processing elements 54-1, 54-2. (Collectively, configurable processing elements 54, and generically, configurable processing element 54). As will be explained in greater detail below, configurable processing elements 54 are each configured to implement at least part of a computing process 66 or one or more computing processes 66. It should be understood that machine 50 is merely a schematic representation and that when implemented, a computing machine in accordance with the teachings herein will contain hundreds, thousands or even millions of configurable processing elements like elements 54.

In a present embodiment, elements 54 are based on FPGAs, however, other types of configurable processing elements either presently known, or developed in the future, are contemplated. Processing elements 54 are connected as peers in a communication network, which is contrasted with systems where some processing elements are utilized as slaves, coprocessors or accelerators that are controlled by a master processing element. It should be understood that in the peer network some processing elements could be microprocessors, graphics processing units, or other elements capable of computing. These other elements can utilize the same communications infrastructure in accordance with the teachings herein.

Element 54-1 and element 54-2 contain two different realizations of computing processes, 66-1 and 66-2, respectively, either of which can be used in the implementation of machine 50.

Process 66-1 is realized using a structure referred to herein as a hardware computing engine 77. A hardware computing engine implements a computing process at a hardware level—in much the same manner that any computational algorithm can be implemented as hardware—e.g. as a plurality of appropriately interconnected transistors or logic functions on a silicon chip. The hardware computing engine approach can allow designers to take advantage of finer granularities of parallelism, and to create a solution that is optimized to meet the performance requirements of a process. An advantage of a hardware computing engine is that only the hardware relevant to performing a process is used to create process 66-1, allowing many small processes 66-1 to fit within one configurable processing element 54-1 or one large process 66-1 to span across multiple configurable processing elements 54. Hardware engines can also eliminate the overhead that comes with using software implementations. Increasing the number of operations performed by a process 66-1 implemented as a hardware computing engine 77 can be achieved by modifying the hardware computing engine 77 to capitalize on parallelism within the particular computing process 66-1.

Process 66-2 is realized using a structure referred to herein as an embedded microprocessor engine, or embedded microprocessor 78. An embedded microprocessor implements computing process 66-2 at a software level—in much the same manner that software can be programmed to execute on any microprocessor. Microprocessor cores in element 54-2 that are implemented using the configurable processing element's programmable logic resources (called soft processors) and microprocessor cores incorporated as fixed components in the configurable processing element are both considered embedded microprocessors. Although using embedded microprocessors in the form of 66-2 to implement processes is relatively straightforward, this approach can suffer from drawbacks in that, for example, the maximum level of parallelism that can be achieved is limited.

As will be discussed in greater detail below, the choice as to whether to implement computing processes as computing engines rather than as embedded microprocessors will typically be based on whether there will be a beneficial performance improvement.

Process 66-1 and Process 66-2 are interconnected via a communication link 58. Communications between processes 66 via link 58 are based on a message passing model. A presently preferred message passing model is the Message Passing Interface (“MPI”) standard—see http://www.mpi-forum.org/docs. However, other message passing models are contemplated. Because process 66-1 is hardware-based, process 66-1 includes a message passing engine (“MPE”) 62 that is hardwired into process 66-1. MPE 62 thus handles all messaging via link 58 on behalf of process 66-1. By contrast, because process 66-2 is software based, the functionality of MPE 62 can be incorporated directly into the software programming of process 66-2 or MPE 62 can be attached to the embedded microprocessor implementing process 66-2, obviating the need for the software implementation of the MPE 62.

The use of a message-passing model can facilitate the use of a distributed memory model for machine 50, as it can allow machines based on the architecture of machine 50 to scale well with additional configurable processing elements. Each computing process 66 implemented on one or more elements 54 thus contain a separate instance of local memory, and data is exchanged between processes by passing messages over link 58.

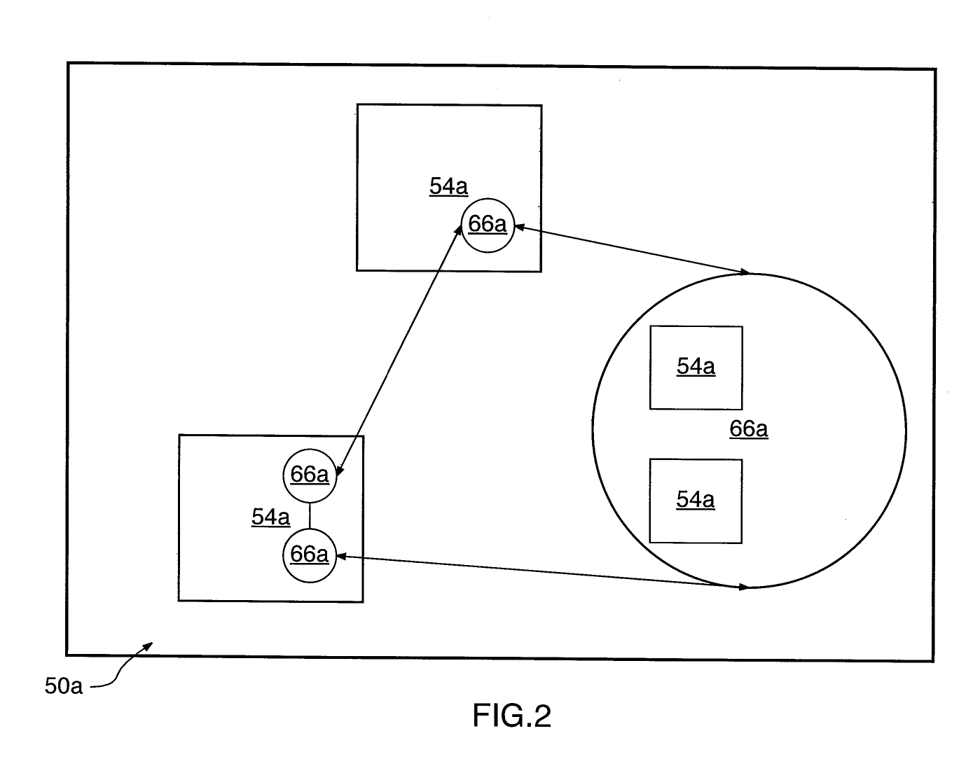

As previously mentioned, elements 54 are each configured to implement at least part of a computing process 66 or one or more computing processes 66. This implementation is shown by example in FIG. 2. FIG. 2 shows another computing machine 50a, which is based on substantially the same architecture as machine 50 and as according to the discussion above. Like elements in machine 50a to like elements in machine 50 have the same reference characters except followed by the suffix “a”. Machine 50a also shows various processes 66a, however, in contrast to machine 50, in a certain circumstance a single element 54a implements a single process 66a, while in another circumstance a single element 54a implements a plurality of processes 66a, and in another circumstance a plurality of elements 54a implements a single process 66a. It should now be understood that there are various ways to implement processes on different elements.

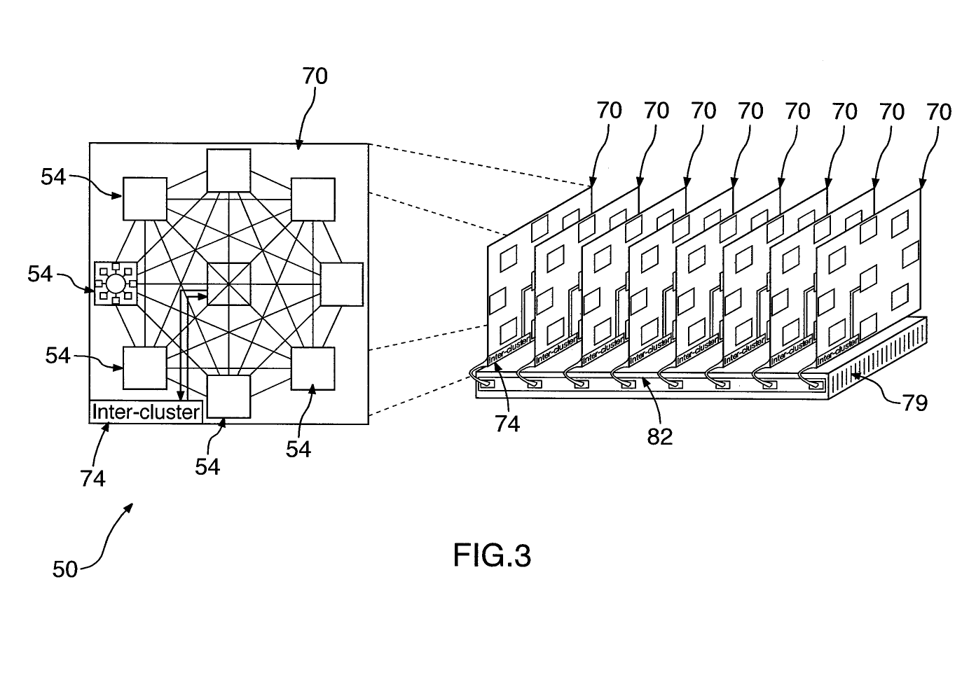

FIG. 3 shows the scalability of machine 50 (or machine 50a, or variants thereof). FIG. 3 shows a plurality of configurable processing elements 54 disposed as a cluster on a single printed circuit board (“PCB”) 70. Each PCB 70 also includes one or more inter-cluster interfaces 74. A plurality of PCBs 70 can then be mounted on a backplane 79 that includes a bus 82 that interconnects the interfaces 74. Any desired networking topology can be used to implement bus 82. An alternate implementation is to have one or more interfaces 74 that are compatible with a switching protocol, such as ten Gigabit Ethernet, and to use a switch, such as a ten Gigabit Ethernet switch to provide the connectivity between each PCB 70.

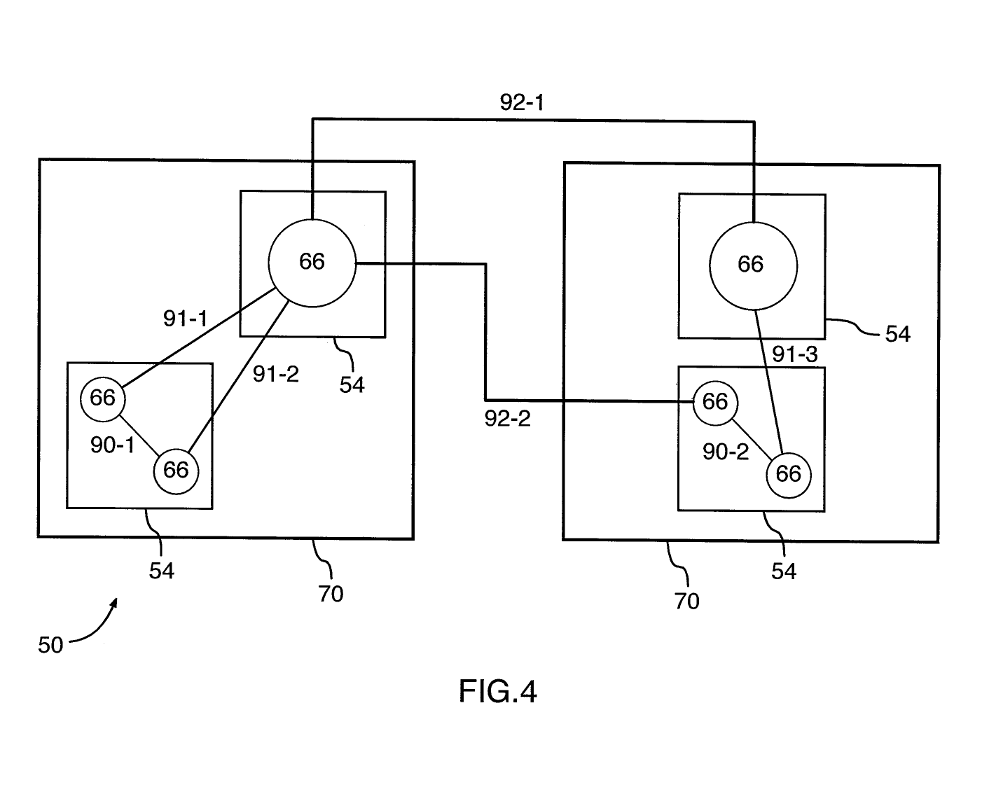

FIG. 4 shows three different instances of communication link 58 between computing processes 66. A link 90, shown as 90-1 and 90-2, is a communication link 58 between processes 66 implemented within one element 54. A link 91, shown as 91-1, 91-2 and 91-3, is a communication link 58 between two processes 66 implemented in separate elements 54 but within one PCB 70. A link 92, shown as 92-1 and 92-2, is a communication link 58 between two processes 66 implemented in separate elements 54 on two different PCBs 70. This approach makes the machine 50 appear logically as a collection of processes 66 interconnected by communication links 58. This allows the user to program the machine 50 as a single large configurable processing element 54 instead of a collection of separate configurable processing elements.

A specific example of a configurable processing element for implementing elements 54 is the Xilinx Virtex-II Pro XC2VP100 FPGA, which features twenty high-speed serial input/output multi-gigabit transceiver (MGT) links, 444 multiplier cores, 7.8 Mbits in distributed BlockRAM (internal memory) structures and two embedded PowerPC microprocessors. Intra-FPGA communication 90 (i.e. communication between two processes 66 within an element 54) is achieved through the use of point-to point unidirectional first-in-first-out hardware buffers (“FIFOs”). The FIFOs can be implemented using the Xilinx Fast Simplex Link (FSL) core, as it is fully-parameterizable and optimized for the Xilinx FPGA architecture. Computing engines 77 and embedded microprocessors 78 both use the FSL physical interface for sending and receiving data across communication channels. FSL modules provide ‘full’ and ‘empty’ status flags that can be used by transmitting and receiving computing engines as flow control and synchronization mechanisms. Using asynchronous FSLs can allow each computing engine 77 or embedded microprocessor 78 to operate at a preferred or otherwise desirable clock frequency, thereby providing better performance and making the physical connection to other components in the system easier to manage.

Inter-FPGA Communications 91 (i.e. communication between processes 66 in separate elements 54) on a PCB 70 in machine 50 uses two components. The first is to transport the data from the process to the I/O of the FPGA using the resources in the FPGA. The second is to transport the data between the I/Os of the FPGAs. The latter can use multi-gigabit transceiver (MGT) hardware to implement the physical communication links. Twenty MGTs are available on the XC2VP100 FPGA, each capable of providing 2×3.125 Gbps of full-duplex communication bandwidth using only two pairs of wires. Future revisions of both Xilinx and Altera FPGAs may increase this data rate to over ten Gbps per channel. Consider a fully-connected network topology used to interconnect eight FPGAs on a cluster PCB. Using MGT links to implement this topology requires only 112 pairs of wires, and yields a maximum theoretical bisection bandwidth of 2×32.0 Gbps (assuming 2×2.0 Gbps per link) between the eight FPGAs. For comparison, the BEE2 multi-FPGA system requires 808 wires to interconnect five FPGAs and can obtain a maximum bi-section bandwidth of 2×80.0 Gbps between four computing FPGAs. (For further discussion on BEE and BEE2 see C. Chang, K. Kuusilinna, B. Richards, A. Chen, N. Chan, R. W. Brodersen, and B. Nikolic in Rapid Design and Analysis of Communication Systems Using the BEE Hardware Emulation Environment in Proceedings of RSP '03, pages 148-, 2003; and see C. Chang, J. Wawrzynek, and R. W. Brodersen. in BEE2:A High-End Reconfigurable Computing System in IEEE Des. Test '05, 22(2):114-125, 2005.) Therefore, PCB complexity can be reduced considerably by using MGTs as a communication medium, and with 10.0 Gbps serial transceivers on the horizon, bandwidth will increase accordingly.

The Aurora core available from Xilinx is designed to interface directly to MGT hardware and provides link-layer communication features. An additional layer of protocol, implemented in hardware, can be used to supplement the Aurora and MGT hardware cores. This additional layer can provide reliable transport-layer communication for link 91 between processes 66 residing in different FPGAs 54, and can be designed to use a lightweight protocol to minimize communication latency. Other cores for interfacing to the MGT and adding reliability can also be used.

Although the use of MGTs for the implementation of communication links 91 can reduce the complexity of the PCB 70, using MGTs is not a requirement. For example, parallel buses, as used in the BEE2 design, provide the advantage of lower latency and can be used when the PCB design complexity can be managed.

Communication links 92 between PCBs 70 require three components. The first is to transport data from the process to the I/O of the FPGA using the resources in the FPGA. The second is to transport the data from the I/O of the FPGA to an inter-cluster interface 74 of the PCB. The third is to transport the data between interfaces 74 across bus 82 or a switch. The switch implementation can be based on the MGT links configured to emulate standardized high-speed interconnection protocols such as Infiniband or 10-Gbit Ethernet. The 2×10.0 Gbps 4×SDR subset of the Infiniband specification can be implemented by aggregating four MGT links, enabling the use of commercially-available Infiniband switches for accomplishing the global interconnection network between clusters. The switch approach reduces the design time of the overall system, and provides a multitude of features necessary for large-scale systems, such as fault-tolerance, network provisioning, and scalability.

The interface to all instances 90, 91, 92 of link 58 as seen by all processes 66 can be made consistent. By way of one non-limiting example, the FIFO interface used for the intra-FPGA communication 90 can be used as the standardized physical communication interface throughout machine 50. This means that all links 91 and 92 that leave an FPGA will also have the same FIFO interface as the one used for the intra-FPGA links 90. The result is that the components used to assemble any specific computation system in the FPGAs can use the same interface independent of whether the communications are within one FPGA or with other FPGAs.

Multiple instances of link 90 can be aggregated over one physical FSL. Multiple instances of link 91 can be aggregated over one physical MGT link or bus. Multiple instances of link 92 can be aggregated over one physical connection over bus 82 or a network switch connection if a switch is used.

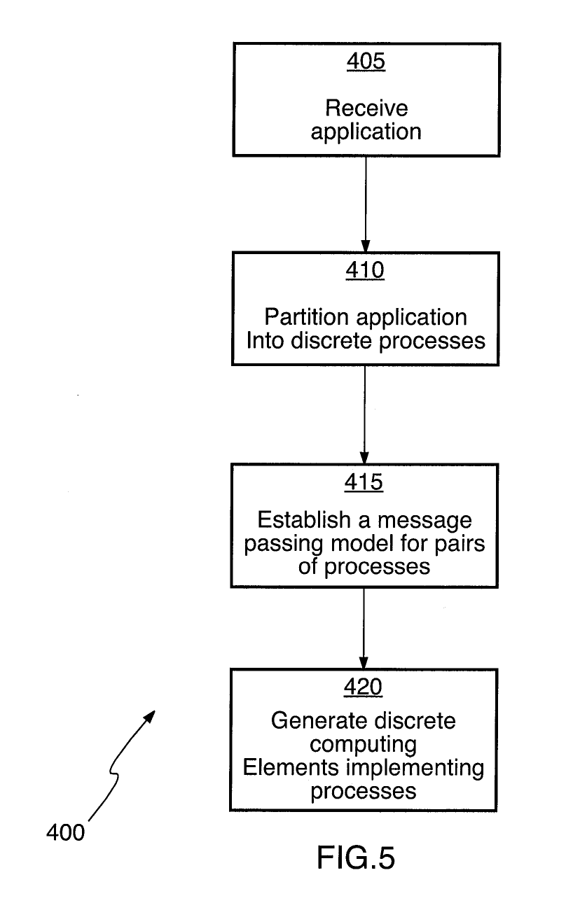

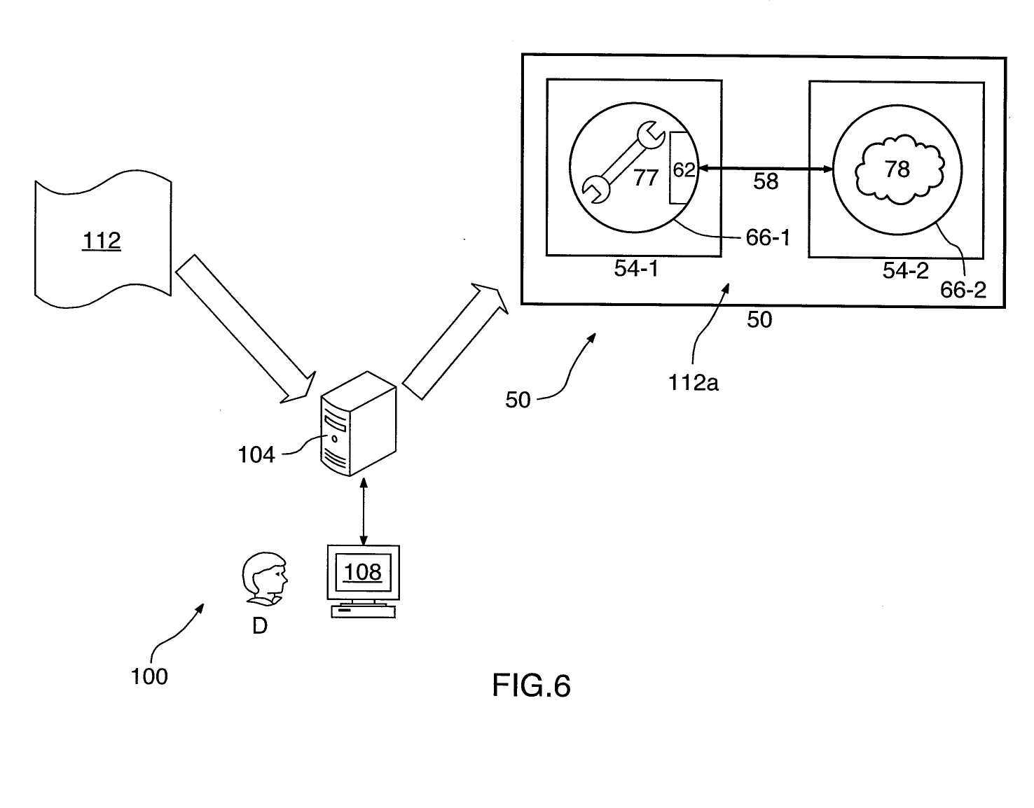

Referring now to FIG. 5, a method for programming a computing machine is depicted in the form of a flow-chart and indicated generally at 400. Method 400 can be used to develop programs for a single configurable processing element 54, machine 50, machine 50a, PCB 70, and/or pluralities thereof and/or combinations and/or variations thereof. To assist in the explanation of method 400, reference will be made to the previous discussions in relation to the single configurable processing element 54, machine 50, machine 50a, PCB 70. Method 400 can be performed using any appropriate or suitable or desired level of automation. Method 400 can be performed entirely manually, but will typically be performed using, or with the assistance of, a general purpose computing system such as the system 100 shown in FIG. 6. System 100 comprises a computer-tower 104 and a user terminal device 108. Computer-tower 104 can be based on any known or future contemplated computing environment, such as a Windows, Linux, Unix or Solaris based desktop computer. User terminal device 108 can include a mouse, keyboard and display to allow a developer D to interact with computer-tower 104 to manage the performance of method 400 on computer-tower 104.

Referring again to FIG. 5, beginning first at step 405, an application is received. The application of step 405 is represented as application 112 in FIG. 6. Application 112 can be any type of application that is configured for execution on a central processing unit of a computer, be that a micro-computer, a mini-computer, a mainframe or a super-computer. Typically, application 112 will include at least one computationally intensive segment. A computationally intensive segment is a section of an application that consumes a significant fraction of the overall computing time of the application. One example would be a computation sequence that is performed repeatedly on many different sets of data. However, method 400 can also be particularly suitable for applications that are typically performed using super-computers. Application 112, for example, can be based on applications that perform molecular dynamics (MD) simulations, which include a highly-parallelizable n-body problem with computational complexity of O(n²). Indeed, there are often two dominant types of calculations that constitute over 99% of the computational effort in an MD application, each requiring a different hardware accelerator structure. Method 400 can be used to develop a working MD simulator that scales and provides orders of magnitude in speed increases. However, application 112 need not be based on MD and indeed method 400 can be used to solve many other computing challenges, such as finite element analysis, seismic imaging, financial risk analysis, optical simulation, weather prediction, and electromagnetic or gravity field analysis.

Thus, at step 405, application 112 in the form of source code in a language, such as, by way of non-limiting examples, C or C++, and in certain circumstances it is contemplated that the language can even be object code, implemented with the assistance of a computer aided design (“CAD”) tool, is received at computer-tower 104. Next, at step 410, application 112 is analyzed and partitioned into separate processes. Preferably, such processes are well-defined as part of performance of step 410 so that relevant processes can be replicated to exploit any process-level parallelism available in application 112. Also preferably, each process is defined during step 410 so that relevant processes can be translated into processes 66 suitable for implementation as hardware computing engines 77, execution on embedded processors 78 or execution on other elements capable of computing, such as, by way of non-limiting examples, microprocessors or graphics processors. Inter-process communication is achieved using a full implementation of a MPI message passing library used in a workstation environment, allowing the application to be developed and validated on a workstation. This approach can have the advantage of allowing developer D access to standard tools for developing, profiling, and debugging parallel applications. Additionally, step 410 will also include steps to define each process so that each process is compatible with the functionality provided by a message passing model that will be used at step 415. An example library that can be used to facilitate such definition is shown in Table I. Once step 410 is complete, a software emulation of the application to be implemented on the machine 50 can be run on the tower 104. This validates the implementation of the application using the multiple processes and message-passing model.

TABLE I
Utility Functions

| | |
|---|---|
| MPI_Init | Initializes TMD-MPI Environment |
| MPI_Finalize | Terminates TMD-MPI Environment |
| MPI_Comm_rank | Get rank of calling process in a group |
| MPI_Comm_size | Get number of processes in a group |
| MPI_Wtime | Returns number of seconds elapsed since |
| | application initialization |

Point-to-Point Functions

| | |
|---|---|
| MPI_Send | Sends a message to a destination process |
| MPI_Recv | Receives a message from a source process |

Collective Functions

| | |
|---|---|
| MPI_Barrier | Blocks execution of calling process until all |
| | other processes in the group reach this |
| | routine |
| MPI_Bcast | Broadcasts message from root process to all |
| | other processes in the group |
| MPI_Reduce | Reduces values from all processes in the |
| | group to a single value in root process |
| MPI_Gather | Gathers values from a group of processes |

Next at step 415, a message passing model is established for pairs of processes defined at step 410. Step 415 takes the collection of software processes developed in step 410 and implements them as computing processes 66 on a machine such as machine 50, but, at this stage, only using embedded microprocessors 78 and not hardware computing engine 77. Each microprocessor 78 contains a library of MPI-compliant message-passing routines designed to transmit messages using a desired communication infrastructure—e.g. Table I. The standardized interfaces of MPI allows the software code to be recompiled and executed on the microprocessors 78.

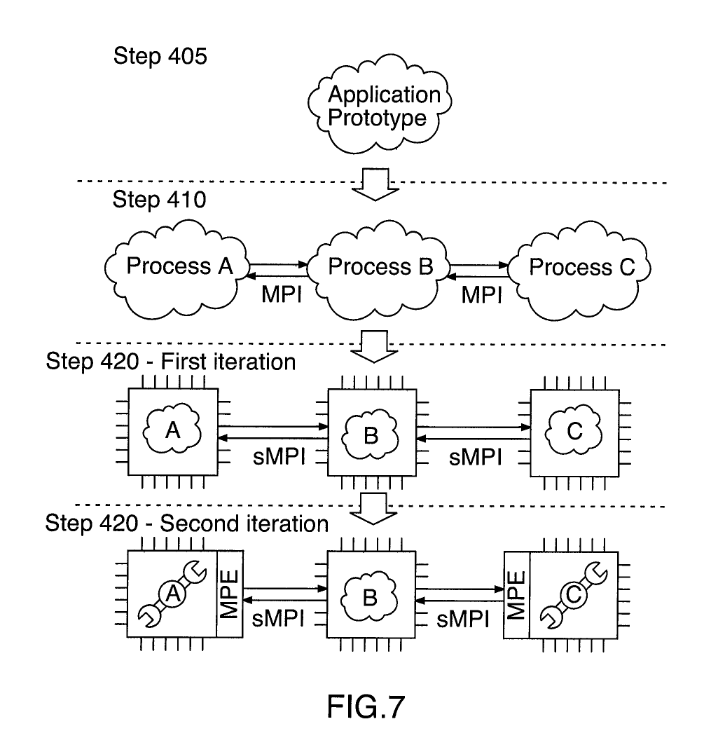

Next, at step 420, computing engines 77 and embedded microprocessors 78 are generated that implement the processes defined at step 410 according to the MPI defined at step 415. Note that, step 420 at least initially, in a present embodiment, contemplates only the creation of a machine that is based on embedded microprocessors 78, such that the execution of the entire application 112 is possible on a machine based solely on embedded microprocessors 78. Such execution thus allows the interaction between each microprocessor 78 to be tested and to validate the architecture of the machine—and, by extension, to provide data as to which of those microprocessors 78 are desirable candidates for conversion into hardware computing engines 77. FIG. 7 illustrates the complete performance of method 400 (omitting certain steps) including at least two iterations at step 420.

The placement of the embedded microprocessors 78 in each configurable processing element 54 should reflect the intended network topology, i.e., number and connectivity of links 90, 91, and 92 in the final implementation (when all iterations of Step 420 are complete) where some of the microprocessors 78 of Step 420 have been replaced with hardware computing engines 77. The result of Step 420 after the first iteration is a software implementation of the application resulting from Step 410 on the machine 50. This is done to validate that the control and communication structure of the application 112a works on machine 50. If further debugging is required, the implementations of the computing processes 66 are still in software making the debugging and analysis easier.

Thus, step 420 can be repeated, if desired, to convert certain microprocessors 78 into hardware computing engines 77 to further optimize the performance of the machine. In this manner, at least step 420 of method 400 can be iterative, to generate different versions of the machine each with increasing numbers of hardware computing engines 77. Conversion of embedded microprocessors 78 into hardware computing engines 77 can be desired for performance-critical computing processes, while less intensive computing processes can be left in the embedded microprocessor 78 form. Additionally, control-intensive processes that are difficult to implement in hardware can remain as software executing on microprocessors. The tight integration between embedded microprocessors and hardware computing engines implemented on the same FPGA fabric can make this a desired option.

In a present embodiment, translating the computationally intensive processes into hardware engines 77 is done manually by developer D working at terminal 108, although automation of such conversion is also contemplated. Indeed, since application 112 has been already partitioned into individual computing processes and all communication interfaces there between have been explicitly stated, a C-to-Hardware Description Language (“HDL”) tool or the like can also be used to perform this translation. A C-to-HDL tool can translate the C, C++, or other programming language description of a computationally intensive process that is executing on microprocessor 78 into a language such as VHDL or Verilog that can be synthesized into a netlist describing the hardware engine 77, or the tool can directly output a suitable netlist. Once a hardware computing engine 77 has been created, a hardware message-passing engine 62 (MPE) is attached to perform message passing operations in hardware. This computing engine 77 with its attached message-passing engine(s) 62 can now directly replace the corresponding microprocessor 78.

It should now be understood that variations to method 400 and/or machine 50 and/or machine 50a and/or elements 54 are contemplated and/or that there are various possible specific implementations that can be employed. Of note is that the MPI standard does not specify a particular implementation architecture or style. Consequently, there can be multiple implementations of the standard. One specific possible implementation of an implementation of the MPI standard suitable for message passing in the embodiments herein shall be referred to as sMPI (Special Message Passing Interface). The sMPI, itself, represents an embodiment in accordance with the teachings herein. By way of background, current MPI implementations are targeted to computers with copious memory, storage, and processing resources, but these resources may be scarce in machine 50 or a machine like machine 50 that is produced using method 400. In sMPI, a basic MPI implementation is used, but the sMPI encompasses everything between the programming interface to the hardware access layer and does not require an operating system. Although the sMPI is currently discussed herein as for implementation on the Xilinx MicroBlaze microprocessor, the sMPI teachings can be ported to different platforms by modifying the lower hardware interface layers in a manner that will be familiar to those skilled in the art.

In the present embodiment of the sMPI library, message passing functions such as protocol processing, management of incoming and pending message queues, and packetizing and depacketizing of long messages are performed by the embedded microprocessor 78 executing a process 66. The message-passing functionality can be provided by more efficient hardware cores, such as MPE 62. This translates into a reduction in overhead for embedded microprocessors as well as enabling hardware computing engines 77 to communicate using MPI. An example of how certain sMPI functionality can be implemented in hardware is found in K. D. Underwood et al, A Hardware Acceleration Unit for MPI Queue Processing, found In Proceedings of IPDPS '05, page 96.2, Washington D.C., USA, 2006, IEEE Computing Society [“Underwood”], the contents of which are incorporated herein by reference. In Underwood, MPI message queues are managed using hardware buffers, which reduced latency for queues of moderate length while adding only minimal overhead to the management of shorter queues.

The sMPI implementation follows a layered approach similar to the method used by the “MPICH” as discussed in W. P. Gropp et al, “A high performance, portable implementation of the MPI message passing interface standard.” Parallel Computing, 22(6):789-828, September 1996, the contents of which are incorporated herein by reference. An advantage of this technique is that the sMPI can be readily ported to different platforms by modifying only the lowest layers of the implementation.

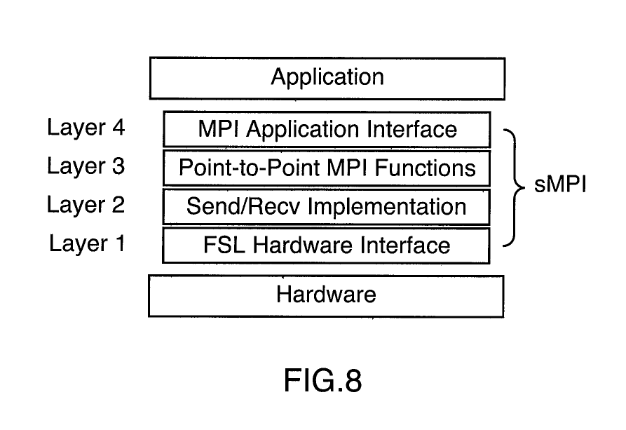

FIG. 8 illustrates the four layers of the sMPI. Layer 4 represents the sMPI functional interfaces available to the application. Layer 3 implements collective operations such as synchronization barriers, data gathering, and message broadcasting (MPI_Barrier, MPI_Gather, and MPIBcast, respectively) using simpler point-to-point MPI primitives. Layer 2 consists of the point-to-point MPI primitives, namely MPI_Send and MPI_Recv. Implementation details such as protocol processing, data packetizing and de-packetizing, and message queue management are handled here. Finally, Layer 1 is comprised of macros that provide access to physical communication channels. Porting sMPI to another platform can involve a replacement of Layer 1 and some minor changes to Layer 2.

sMPI currently implements only a subset of functionality specified by the MPI standard. Although this set of operations is sufficient for an initial MD application, other features can be added as the need arises. Table I lists a limited description of functions that can be implemented, and more can be added.

It is to be reiterated that the particular type of application 112 is not limited. However, an example of application 112 that can be implemented includes molecular simulations of biological systems, which have long been one of the principal application domains of large-scale computing. Such simulations have become an integral tool of biophysical and biomedical research. One of the most widely used methods of computer simulation is molecular dynamics where one applies classical mechanics to predict the time evolution of a molecular system. In MD simulations, empirical molecular mechanics equations are used to determine the potential energy of a collection of atoms as a function of the physical properties and positions of all atoms in the simulation.

The net force acting on each atom is determined by calculating the negative gradient of the potential energy with respect to its position. With the knowledge of both the position and the net force acting on every atom in the system, Newton's equations of motion are solved numerically to predict the movement of every atom. This step is repeated over small time increments (e.g. once every 10⁻¹⁵ seconds) to yield a time trajectory of the molecular system. For meaningful results, these simulations need to reach relatively large length time scales, underscoring the need for scalable computing solutions. Exemplary known software based MD simulators available include CHARMM (See Y. S. Hwang et al, Parallelizing Molecular Dynamics Programs For Distributed-Memory Machines, IEEE Computation Science and Engineering, 2(2):18-29, Summer 1995); AMBER (See D. Case et al, The Amber biomolecular simulation programs. In Proceedings of JCCM '05, volume 26, pages 1668-1688, 2006) and NAMD (see J. C. Phillips et al. Scalable molecular dynamics with NAMD. In Proceedings of JCCM '05, volume 26, pages 1781-1802, 2006).

An MD application was developed using method 400. This version of the MD application performs simulations of noble gases. The total potential energy of the system results from van der Waals forces, which are modeled by the Lennard-Jones 6-12 equation, as discussed M. P. Allen et al. Computer Simulation of liquids, Clarendon Press, New York, N.Y., USA 1987. The application was developed using the design flow of method 400. An initial proof-of-concept application was created to determine the algorithm structure. Next, the application was refined and partitioned into four well-defined processes: (1) force calculations between all atom pairs; (2) summation of component forces to determine the net force acting on each atom; (3) updating atomic coordinates: and (4) publishing the atomic positions. Each task was implemented in a separate process written in C++, and inter-process communication was achieved by using MPICH over standard a switched Ethernet computing cluster.

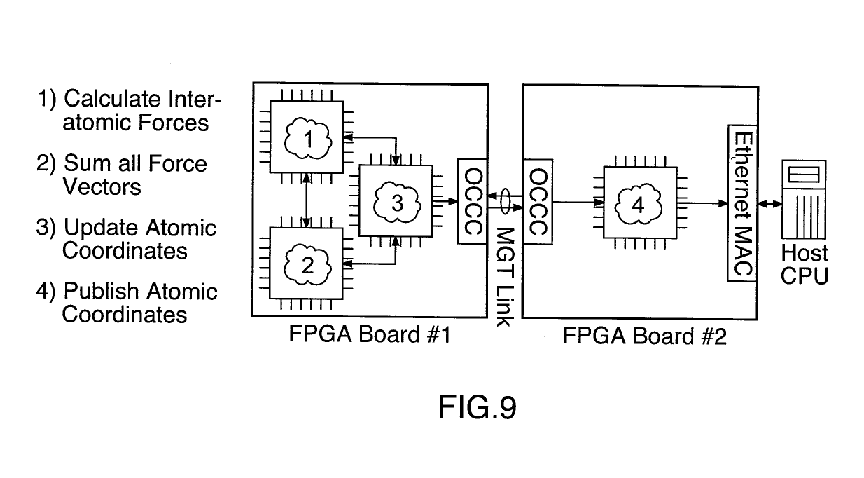

The next step in the design flow was to recompile each of the four simulator processes to target the embedded microprocessors implemented on the final computing machine. The portability of sMPI eliminated the need to change the communication interface between the software processes. The simulator was partitioned onto two FPGA nodes as illustrated in FIG. 9. Each node is implemented using the Amirix AP1100 development board, the details of which can be found in AP1000 PCI Platform FPGA Development Board, Technical Report, Amirix Systems, Inc. October 2005, http://www.amirix.com/downloads/ap1000.pdf.

The FPGA on the first board contains three microprocessors responsible for the force calculation, force summation, and coordinate update processes, respectively. All of the processes communicate with each other using sMPI. The second FPGA board consists of a single microprocessor executing an embedded version of Linux. The second FPGA board also uses sMPI to communicate with the first FPGA board over the MGT link, as well as a TCP/IP-based socket connection to relay atomic coordinates to an external program running on a host CPU.

This initial MD application demonstrates the effectiveness of the programming model by implementing a software application using method 400. The final step is to replace the computationally-intensive processes with dedicated hardware implementations.

The present disclosure provides a novel high-performance computing machine and a method for developing such a machine. The machine can be built entirely using a flexible network of commodity FPGA hardware though other more customized hardware can be used. The machine can be designed for applications that exhibit high computation requirements that can benefit from parallelism. The machine also includes an abstracted, low-latency communication interface that enables multiple computing tasks to easily interact with each other, irrespective of their physical locations in the network. The network can be realized using high-speed serial I/O links, which can facilitate high integration density at low PCB complexity as well as a dense network topology.

A method for developing an application on a machine 50 that is commensurate with the scalability and parallel nature of the architecture of machine 50 is disclosed. Using the MPI message-passing standard as the framework for creating applications, parallel application developers can be provided a familiar development paradigm. Additionally, the portability of MPI enables application algorithms to be composed and refined on CPU-based clusters.

FIG. 9 shows a pair FPGA boards implementing an exemplary application based on the embodiments discussed herein. The application is for determining atomic coordinates and is implemented using four embedded microprocessors. The first three embedded microprocessors are mounted on the first FPGA board, while the fourth embedded microprocessor is mounted on the second FPGA board. The first embedded microprocessor calculates the inter-atomic forces between the atoms. The second embedded microprocessor sums all of the force vectors. The third embedded microprocessor updates the atomic coordinates. The fourth embedded microprocessor is on the second FPGA board and publishes the atomic coordinates. The FPGA boards are connected by an MGT link, while the second FPGA board is connected to a server or other host central processing unit via a standard Ethernet link.

The contents of all third-party materials referenced herein are hereby incorporated by reference.

1. A method for converting a software application for execution on a configurable computing system, the method comprising the steps of:
a) receiving an application configured for execution on one or more central processing units;
b) partitioning said application into discrete processes;
c) establishing at least one message passing interface between pairs of said processes by using a defined communication protocol, such as a standardized or proprietary message-passing application programming interface;
d) porting said processes onto at least one configurable processing element to exploit the parallelism of the application by using embedded processors communicating with the defined protocol;
e) replacing at least one process executing on embedded microprocessors with hardware circuits that implement the same function as the software processes.

2. The method of claim 1 where the defined communication protocol is implemented in software in the embedded processors.

3. The method of claim 1 where the defined communication protocol can be implemented in hardware using a defined physical interface and attached to embedded processors in the configurable computing system to provide acceleration of the protocol processing and data transfer.

4. The method of claim 3 where the protocol is implemented via hardware attached to each said hardware circuit providing the hardware circuit the physical means to communicate using the defined communication protocol and standardized physical interface.

5. The method of claim 4 whereby standardized physical interface is an MGT link.

6. A method for design of a scalable configurable processing element-based computing machine application comprising:
receiving an application prototype;
partitioning said prototype into a plurality of discrete software executable processes and establishing at least one software-based message passing interface between pairs of said processes;
porting each of said discrete software processes into a plurality of configurable processing element-based embedded microprocessors;
and establishing at least one hardware-based message passing interface between pairs of said configurable processing element-based embedded microprocessors.

7. The method of claim 6 further comprising:
converting at least one of said configurable processing element-based embedded microprocessors executing a respective one of said discrete software processes into a configurable processing element-based hardware computing engine.

8. The method of claim 7 comprising, prior to said converting step:
determining which of said configurable processing element-based embedded microprocessors executing a respective one of said discrete software processes is a desirable candidate for conversion into an configurable processing element-based hardware computing engine.

9. The method of claim 8 wherein said determining step is based on selecting processes that operate using more parallel operations than other ones of said processes.

10. A configurable processing element-based computing machine comprising:
a plurality of configurable processing element-based computing engines interconnected via a communication structure;
each of said configurable processing element-based computing engines comprising a processing portion for implementing a computing process and a memory portion for storage of local data respective to said computing process;
each of said configurable processing element-based computing engines further implementing a message passing interface operably connected to said processing portion and said memory portion and said communication structure; each message passing interface on each of said computing engines configured to communicate with at least one other adjacent computing engine via said communication structure;
said message passing interface configured to communicate requests and responses to other message passing interfaces on other ones of said computing engines that are received via said communication structure; said requests and responses reflecting states of at least one of said processing portion and said memory portion respective to one of said message passing interfaces.

11. The computing machine of claim 10 wherein at least one of said computing engines is realized with an embedded microprocessor engine that implements said processing portion.

12. The computing machine of claim 10 wherein at least one of said computing engines is realized with a hardware computing engine that implements said processing portion.

13. The computing machine of claim 10 wherein each computing process in a pair of communicating processes connects to a communication channel by means of a standardized physical interface.

14. The computing machine of claim 13 wherein communicating computing engines are contained within one configurable processing element communicate using a link implemented with resources of the configurable processing element.

15. The computing machine of claim 14 wherein the communicating computing engines are implemented in different configurable processing elements residing on the same printed circuit board; said computing engines are configured to communicate using internal communication links to transport information to the input/output ports of the configurable computing element; said connection between the input/output ports of the respective configurable processing elements utilize printed circuit board resources and the transceiver functions available in the configurable processing elements.

16. The computing machine of claim 15 wherein the communicating computing engines are implemented in different configurable processing elements residing on separate printed circuit boards; said printed circuit boards are interconnected through their respective inter-printed circuit board interfaces; said interfaces connected to each other by means of one of a direct connections, a bus or a switch; said computing engines configured to communicate using the internal communication links to transport information to the input/output ports of each configurable computing element; wherein the connection between the input/output ports of the respective configurable processing elements to the inter-printed circuit board interfaces utilize printed circuit board resources and the transceiver functions available in the configurable processing elements.

17. A configurable processing element-based computing machine comprising:
a plurality of configurable processing elements interconnected via a communication structure; each of said configurable processing elements comprising a processing portion for implementing a computing process and a memory portion for storage of local data respective to said computing process.

18. The computing machine of claim 17 wherein at least one of said configurable processing elements includes an embedded microprocessor engine that implements said processing portion.

19. The computing machine of claim 17 wherein at least one of said configurable processing elements includes a hardware computing engine that implements said processing portion.

20. The computing machine of claim 17 wherein said configurable processing elements implement a plurality of computing processes.

21. The computing machine of claim 20 wherein at least one of said configurable processing elements includes an embedded microprocessor engine that implements at least a portion of said plurality of computing processes.

22. The computing machine of claim 20 wherein at least one of said configurable processing elements includes a hardware computing engine that implements at least a portion of said plurality of computing processes.

23. The computing machine of claim 20 wherein at least one of said configurable processing elements includes an embedded microprocessor engine that implements at least a portion of said plurality of computing processes and at least one of said configurable processing elements includes a hardware computing engine that implements at least a portion of said plurality of computing processes.

24. The computing machine of claim 23 wherein a message passing interface is disposed between said elements to provide a communication pathway therebetween.
